(19) United States
(12) Patent Application Publication
(10) Pub. No.: US 2023/0216889 A1
(43) Pub. Date: Jul. 6, 2023

(54) ARTIFICIAL INTELLIGENCE FOR ALLOCATION OF SECURE SHARED SPACES

(71) Applicant: Kyndryl, Inc., New York, NY (US)

(72) Inventors: Roxana MONGE NUNEZ, Pérez Zeledón (CR); Shikhar KWATRA, San Jose, CA (US)

(21) Appl. No.: 17/565,786

(22) Filed: Dec. 30, 2021

(51) Int. Cl. H04L 9/40; G06Q 10/10; G06N 3/08

(52) U.S. Cl. CPC H04L 63/20; G06Q 10/1093; G06N 3/08

(57) ABSTRACT

A system and method for managing secure shared office space is provided. In embodiments, a method includes: receiving, by a computing device, a workspace request from a user, the workspace request including scheduling requirements for an activity; determining, by the computing device, security requirements associated with the workspace request utilizing a trained convoluted neural network (CNN) based on participant data including information regarding security requirements of the user and shared workspace information for a pool of shared workspaces; determining, by the computing device, that one or more of the shared workspaces in the pool of shared workspaces meets the security requirements associated with the workspace request; determining, by the computing device, that the one or more of the shared workspaces meets the scheduling requirements of the request; and automatically generating and sending, by the computing device, a notification to the user including the one or more of the shared workspaces.

### BACKGROUND

Aspects of the present invention relate generally to shared space management and, more particularly, to determining allocation of secure shared spaces using artificial intelligence.

Utilizing a flexible workspace can be a fast and nimble path to market for companies big and small. By optimizing space in a building, an organization can improve its bottom line and enable a productive environment that increases engagement of occupants. Successful space management may hinge on an organizations ability to understand their workspace needs.

### SUMMARY

In a first aspect of the invention, there is a computer-implemented method including: receiving, by a computing device, a workspace request from a user, the workspace request including scheduling requirements for an activity; determining, by the computing device, security requirements associated with the workspace request utilizing a trained convoluted neural network (CNN) based on participant data including information regarding security requirements of the user and shared workspace information for a pool of shared workspaces; determining, by the computing device, that one or more of the shared workspaces in the pool of shared workspaces meets the security requirements associated with the workspace request; determining, by the computing device, that the one or more of the shared workspaces meets the scheduling requirements of the workspace request; and automatically generating and sending, by the computing device, a notification to the user including the one or more of the shared workspaces.

In another aspect of the invention, there is a computer program product including one or more computer readable storage media having program instructions collectively stored on the one or more computer readable storage media. The program instructions are executable to: obtain participant data including information regarding security requirements of a user and shared workspace information for a pool of shared workspaces; receive a workspace request from the user, the workspace request including scheduling requirements for an activity; determine security requirements associated with the workspace request utilizing a trained convoluted neural network (CNN) based on the participant data; determine whether one or more of the shared workspaces in the pool of shared workspaces meets the security requirements associated with the workspace request; and in response to the determining that the one or more of the shared workspaces does not meet the security requirements, automatically generate and send a notification to the user indicating that now secure shared workspaces are available.

In another aspect of the invention, there is system including a processor, a computer readable memory, one or more computer readable storage media, and program instructions collectively stored on the one or more computer readable storage media. The program instructions are executable to: obtain participant data including information regarding security requirements of a user and shared workspace information for a pool of shared workspaces; receive a workspace request from the user, the workspace request including scheduling requirements for an activity; determine security requirements associated with the workspace request utilizing a trained convoluted neural network (CNN) based on the participant data; determine whether one or more of the shared workspaces in the pool of shared workspaces meets the security requirements associated with the workspace request; and in response to the determining that the one or more of the shared workspaces does not meet the security requirements, automatically generate and send a notification to the user indicating that now secure shared workspaces are available.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 depicts an overview of a method of allocating shared spaces based on security parameters in according to aspects of the invention.

FIG. 6 depicts an exemplary convoluted neural network in accordance with aspects of the invention.

FIG. 7 shows a flowchart of an exemplary method in accordance with aspects of the invention.

FIG. 8 is a diagram depicting the sharing of learned action selection policies in accordance with aspects of the invention.

### DETAILED DESCRIPTION

Aspects of the present invention relate generally to shared space management and, more particularly, to determining allocation of secure shared spaces using artificial intelligence (AI). In embodiments, a method and system are provided that learn from security parameters of users (e.g., a company's policies, Internet of Things (IoT) devices, etc.) over time to provide shared workspace allocation recommendations using a multi-agent deep reinforcement learning model (MADRL). The term shared workspace or shared workspace location as used herein refers to workspaces that are allocatable/assignable to more than one user. Shared workspace locations may comprise an enclosed workspace (e.g., enclosed conference room) or an open workspace (e.g., a desk in an open-concept floorplan), for example. In implementations, shared workspaces may be available at different geographic locations (e.g., different buildings, floors of buildings, etc.), and may be owned and/or managed by a common entity or by multiple different entities.

In embodiments, a computer-implemented process is provided for managing shared office space, the computer-implemented process including: receiving information representative of security parameters associated with a company and individuals of the company including company policies, shared office space profiles and IoT device data, security databases and user profiles associated with respective users; in response to receiving a request for use of a shared office space from a user, including an intended activity, a date and a time, evaluating, by convolutional neural network (CNN), security requirements associated with the request in view of criteria including the security parameters associated with profiles of the shared office, the user and the company; in response to receiving a satisfactory evaluation result, identifying possible shared office space; in response to a determination a subset of possible shared office spaces are available for the intended activity, date and time, recommending the shared office spaces of the subset of possible shared office spaces, to the user; and in response to receiving at least one of an unsatisfactory evaluation result and a lack of available possible shared office spaces, notifying the user to change the request.

As organizations incorporate flexible work alternatives into their processes, the need for flexible workspaces (e.g., shared workspaces) grows. Successful space management may hinge on an organization's ability to understand their workspace needs. Advantageously, implementations of the invention provide an artificial intelligence system and method for allocating shared workspaces in a manner that meets security needs of individuals. Embodiments constitute an improvement in the field of security management, and utilize a new multi-agent deep reinforcement learning model (MADRL) to recommend shared space allocations to users to meet individual security needs. In implementations, a trained convoluted neural network (CNN) of the MADRL utilizes security parameter inputs to generate an output for a user comprising one or more recommended workspaces for a particular activity, date, and time.

It should be understood that, to the extent implementations of the invention collect, store, or employ personal information provided by, or obtained from, individuals (for example, calendar information of a user), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

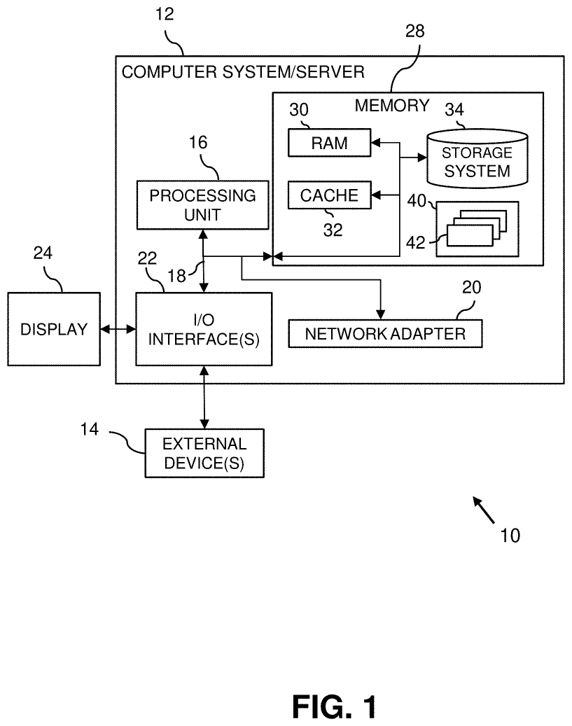

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

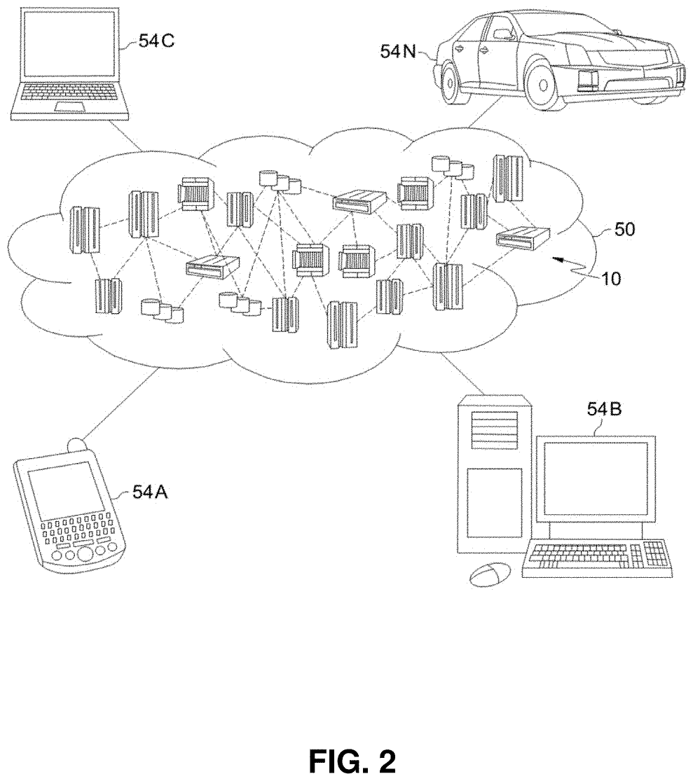

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

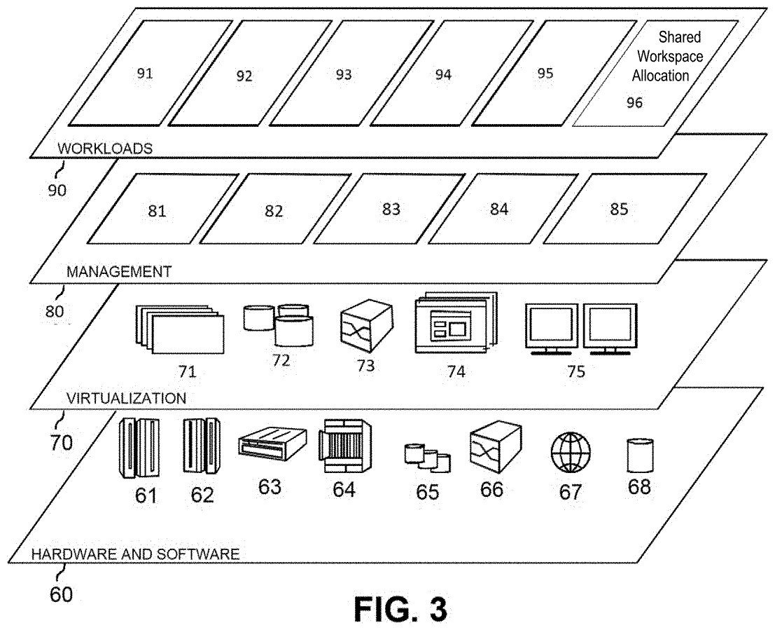

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and shared workspace allocation 96.

Implementations of the invention may include a computer system/server 12 of FIG. 1 in which one or more of the program modules 42 are configured to perform (or cause the computer system/server 12 to perform) one of more functions of the shared workspace allocation 96 of FIG. 3. For example, the one or more of the program modules 42 may be configured to: obtain participant data including information regarding security requirements of a user and shared workspace information for a pool of shared workspaces; receive a workspace request from the user, the workspace request including scheduling requirements for an activity; determine security requirements associated with the workspace request utilizing a trained convoluted neural network (CNN) based on the participant data; determine whether one or more of the shared workspaces in the pool of shared workspaces meets the security requirements associated with the workspace request; determine whether the one or more of the shared workspaces meets the scheduling requirements of the workspace request; and in response to the determining whether the one or more of the shared workspaces meets the security requirements, automatically generate and send a notification to the user including the one or more of the shared workspaces.

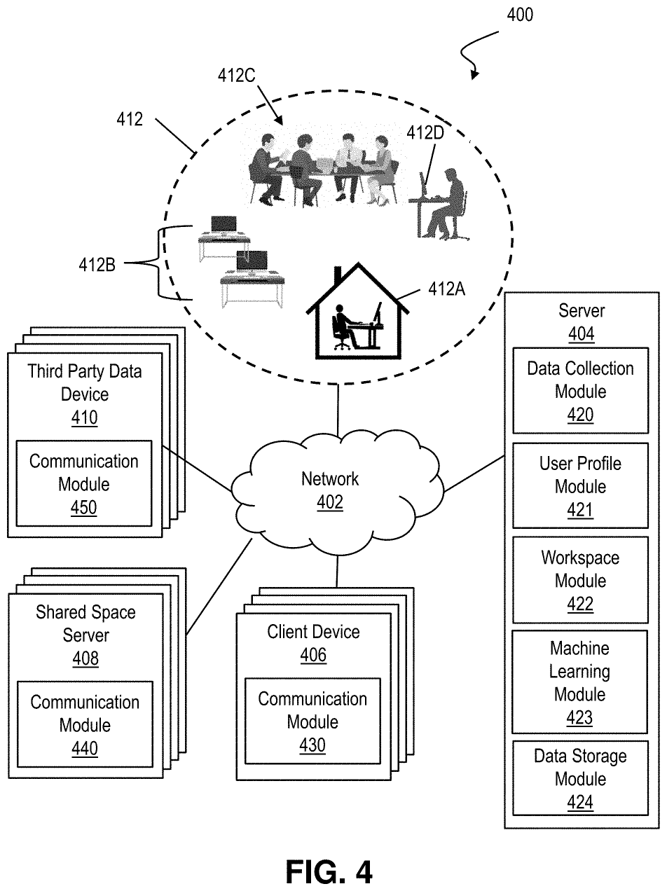

FIG. 4 shows a block diagram of an exemplary workspace sharing environment 400 in accordance with aspects of the invention. In embodiments, the workspace sharing environment 400 includes a network 402 enabling communication between one or more of: a server 404, one or more client devices 406, one or more shared space servers 408, and one or more third party data devices 410. A pool of shared workspaces is indicated at 412, wherein each shared workspace may be allocated (e.g., assigned, rented, etc.) to a user for a determined period of time. Shared workspaces may comprise, for example, enclosed workspaces 412A, workspaces in an open concept environment 412B, workspaces for multiple users (e.g., a conference room) represented at 412C, or individual desks 412D. The server 404, the one or more client devices 406, the one or more shared space servers 408, and the one or more third party data devices 410 may each comprise the computer system/server 12 of FIG. 1, or elements thereof.

The server 404 may be a computing node 10 in the cloud computing environment 50 of FIG. 2. In implementations, the server 404 is a special purpose computing device configured to provide shared space allocation services to users of the network 402. The one or more client devices 406 may be local computing devices used by cloud consumers in the cloud computing environment 50 of FIG. 2 (e.g., PDA or cellular telephone 54A, desktop computer 54B, laptop computer 54C, and/or automobile computer system 54N). In implementations, the one or more shared space servers 408 are configured to provide information regarding one or more shared space locations (e.g., a building with multiple shared workspaces available for allocation). In embodiments, the one or more third party data devices 410 are configured to provide third party security information to the server 404. For example, a third party data device 410 may be a law enforcement server providing publicly available information or the status of security (e.g., security alerts) for one or more locations. In embodiments, the one or more shared space servers 408 and/or the one or more third party data devices 410 are computing nodes 10 in the cloud computing environment 50 of FIG. 2.

In embodiments, the server 404 comprises one or more modules, each of which may comprise one or more program modules such as program modules 42 described with respect to FIG. 1. In the example of FIG. 4, the server 404 includes a data collection module 420, a user profile module 421, a workspace module 422, a machine learning module 423, and a data store module 424, each of which may comprise one or more program module(s) 42 of FIG. 1, for example.

In implementations, the data collection module 420 is configured to communicate with respective communication modules 430, 440 and 450 of the one or more client devices 406, the one or more shared space servers 408, and the one or more third party data devices 410. In embodiments, the data collection module 420 obtains user inputs via a user interface (UI) provided by the server 404 to users (e.g., via one or more client devices 406). In aspects, a user input comprises a request for a shared workspace recommendation and/or allocation, wherein the request includes an intended activity of the user (e.g., business meeting), a time for the intended activity, and a date for the intended activity.

In embodiments, the user profile module 421 is configured to obtain user profile information including, for example, information about organizations and individuals within the organizations. In implementations, the user profile information includes security information (e.g., security policies, IoT devices of the user). User profile information may be stored by the data store module 424 in a local or remote data store.

In implementations, the workspace module 422 is configured to obtain information regarding shared workspaces available for allocation in the environment 400. Shared workspaces may be shared workspaces of a single organization, or may be workspaces shared between multiple organizations and/or individual users. Shared workspace information may include, for example, information regarding security provisions at a location, information regarding IoT devices at the location, information regarding availability of workspaces (e.g., allocation schedules), and information regarding features of the workspaces and/or location. Shared workspace information may be stored by the data store module 424 in a local or remote data store.

In embodiments, the machine learning module 423 is configured to feed inputs into one or more CNNs to generate recommended shared workspaces for a user. In implementations, the machine learning module 423 inputs client parameters, third party parameters, location parameters and user parameters into a CNN and outputs recommendations for available shared workspaces that meet security needs of the user.

In aspects of the invention, a data storage module 424 is configured to obtain and store data for input into the CNN (e.g., client parameters, third party parameters, location parameters and user parameters).

The server 404, one or more client devices 406, one or more shared space server 408 and one or more third party data devices may each include additional or fewer modules than those shown in FIG. 4. In embodiments, separate modules may be integrated into a single module. Additionally, or alternatively, a single module may be implemented as multiple modules. Moreover, the quantity of devices and/or networks in the environment 400 is not limited to what is shown in FIG. 4. In practice, the environment 400 may include additional devices and/or networks; fewer devices and/or networks; different devices and/or networks; or differently arranged devices and/or networks than illustrated in FIG. 4.

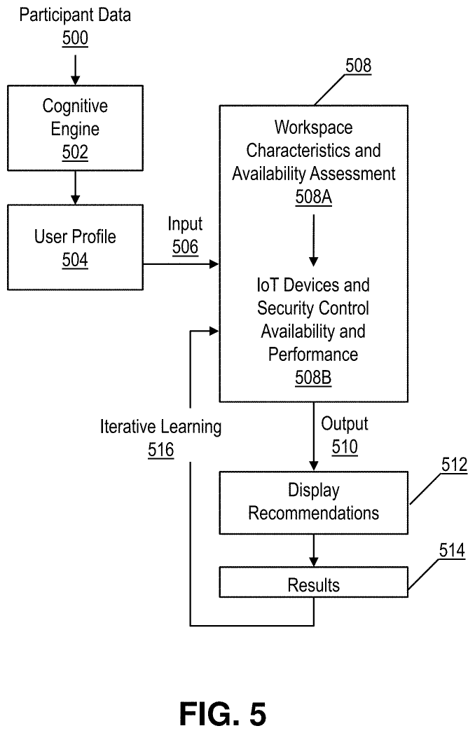

FIG. 5 depicts an overview of a method of allocating shared spaces based on security parameters in according to aspects of the invention. Steps illustrated in FIG. 5 may be carried out in the environment of FIG. 4, and are described with reference to elements depicted in FIG. 4. In the example of FIG. 5, a cognitive engine 502 of the server 404 receives participant data 500 for one or more users, organizations and/or workspace providers. The participant data 500 includes security parameters and policies (e.g., security level of user, security rules of an organization of the user, security resources of a participating workspace location, etc.) and IoT device information (e.g., IoT devices of the user, IoT devices at a participating workspace location).

In embodiments, the cognitive engine 502 comprises a collection of machine learning algorithms (e.g., CNNs) that analyzes the participant data 500 to identify parameters of interest, including security parameters and IoT device parameters. In one example, the cognitive engine 502 is part of the user profile module 421 of the server 404 and generates a user profile 504 based on the participant data 500. By way of example, the cognitive engine 502 may utilize natural language processing models to extract security parameters from security policy data of an organization. Data from the user profile 504 is fed as input 506 to a convoluted neural network (CNN) represented at 508, which performs a workspace characteristics and availability assessment at 508A and an IoT devices and security control availability and performance/function assessment at 508B to generate an output 510 (e.g., in the form of a recommended action). In embodiments, one or more hidden layers of the CNN 508 perform workspace characteristics and availability assessment to determine characteristics/features of a workspace (e.g., user capacity; contents of the space such as desks, computers, number of seats, etc.; structural features such as walls, doors, windows, privacy shades or blinds, soundproofing; or other features). In embodiments, one or more hidden layers of the CNN 508 perform IoT device and security control availability and performance assessment/functions to determine security functionality and options for workspaces in a pool of workspaces. Security performance may include the number and type of IoT devices (e.g., security cameras, security badges, security personnel, etc.), as well as the functionality and control of security devices (e.g., constant real-time monitoring of security cameras by personnel, wireless security measures taken or available, etc.). At 512, the server 404 displays one or more recommendations to a user (e.g., via a UI of the server 404 accessed by a client device 406). A recommendation may include, for example, one or more shared workspaces that comply with user security requirements and are available for a particular activity at a data and time requested by the user. In another example, the recommendation may be a recommendation to change input parameters (e.g., data and time) when no available workspaces meet security needs of the user.

Results of the workspace allocation process of FIG. 5 may be utilized to iteratively train the CNN 508 as indicated at 516, thereby continuously improving the quality or accuracy of the recommendations displayed at 512. For example, the results may comprise a user booking a recommended workspace through the UI of the server 404, wherein the CNN 508 may be further trained using data of the space allocating process. In another example, the results may comprise updating the CNN 508 based on a user rejecting a recommended workspace allocation.

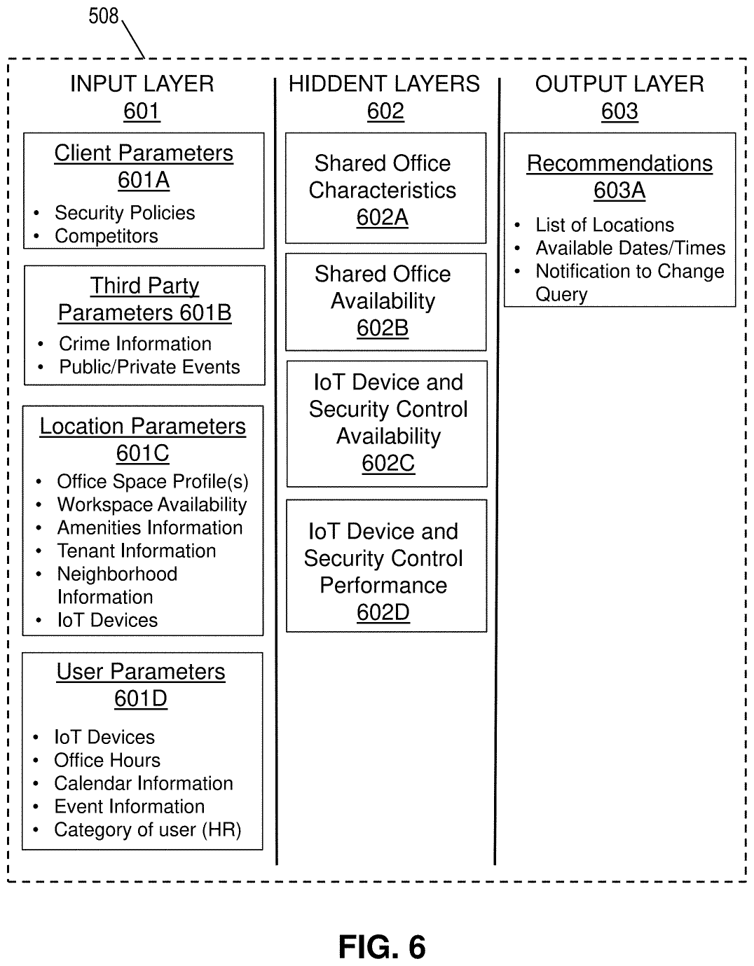

FIG. 6 depicts an exemplary CNN 508 in accordance with aspects of the invention. In the example of FIG. 6, the CNN 508 comprises an input layer 601, a hidden layer 602 (performing convolutions), and an output layer 603. By way of example, the input layer may receives participant data including client parameters 601A (e.g., security policies, list of competitors); third party parameters 601B (e.g., information for locations, public/private event information for locations); location parameters 601C for a participating shared workspace location (e.g., office space profiles, workspace availability, amenities information, tenant information, neighborhood information, IoT devices); and user parameters 601D (e.g., IoT devices of the user, office hours of the user, meeting/calendar information, event information, security level associated with a user, job title or type of user).

With continued reference to FIG. 6, the hidden layers 602 may include multiple layers configured to determine decision-making information such as shared office characteristics 602A; shared office availability 602B; IoT device and security control availability 602C; and IoT device and security control performance/functions 602D. At output layer 603, the CNN 508 may generate one or more outputs or recommendations 603A, such as a list of available shared workspace locations that meet a user's security needs; available dates and times of shared workspace locations that meet a user's security needs; and a notification to change the user request or query when no shared workspace locations are available that meet a user's parameters (e.g., meet security needs and are available for the type of activity requested, at a date and time requested).

In one example, the server 404 assesses security requirements for using shared office spaces based on a company's security parameters and user needs. In this example, the user will be in the shared office location for several hours, and the CNN 508 may determine that several security requirements are needed at the location so that the user can lock his/her computer in a secure location to enable the user to take work breaks.

In another example, the server 404 assesses business security requirements for using a shared office space based on intended use of the spaces. For example, the server 404 may determine that individuals of an organization cannot use shared space locations along with competitors, and therefore provides recommendations accordingly. In embodiments, the server 404 recommends a contract agreement with a shared space owner that prevents sharing of the space with competitors of an organization, or triggers a risk notification or alert to send to a user when there is a risk that a user will be sharing a shared workspace location with a competitor.

In another example, the server 404 assesses the privacy of a shared workspace location for conferences (e.g., a conference call). In this example, a user is expected to have confidential meetings during the day, and the CNN 508 may advise the user to utilize a shared workspace with a high security standard, such as an enclosed office or a location with no people nearby, in order to meet the security needs of the user and/or the user's organization. Alternatively, if the user has no scheduled or anticipated meetings and is expected to work on the creation of a document, then the CNN 508 may advise the user that a shared workspace with an open configuration (as opposed to an enclosed office) is acceptable to meet their security needs.

In another example, the server 404 learns about a type of access that a user requires, and based on that type of access, provides recommendations to the user. For example, if a Human Resources (HR) department of an organization requires a special secure workspace allocation (based on predetermined rules or policies), the CNN 508 will determine workspace allocation recommendations based on whether the workspace meets the requirements for a special secure workspace.

In yet another example, based on a company's security parameters, the server 404 may provide recommendations for renting workspaces. For example, the server 404 may recommend creating a location of shared workspaces at a first floor of a building, where the shared workspaces are available for renting by the public during the weekends. Moreover, the server 404 may recommend moving recreation spaces from a first location to a second location to provide different workplace allocation options.

In implementations, the server 404 learns about shared workspaces over time, and can determine if shared workspaces allocated to a company continue to meet the company's security needs over time. Accordingly, in embodiments, the recommendation output by the CNN 508 may comprise a recommendation to continue using or a recommendation to stop using one or more shared workspaces.

In embodiments, the server 404 provides recommendations to allocate a new shared workspace for a meeting, based on information regarding events. For example, in a case where the server 404 determines that a third-party conference with people outside of a user's organization is scheduled at a shared workspace location, the server 404 may advise the user to select a different shared workspace, due to the currently allocated workspace no longer meeting security needs of the user (due to the increased security risk associated with non-authorized people and additional traffic associated with the third party conference).

In aspects of the invention, the server 404 is configured to analyze databases for new online data, to determine security parameters near a shared workspace location, and associated security risk to the location based thereon. For example, if a building has good security characteristics but is in an unsecured geographic location, the server 404 may recommend that a user utilize another shared workspace location.

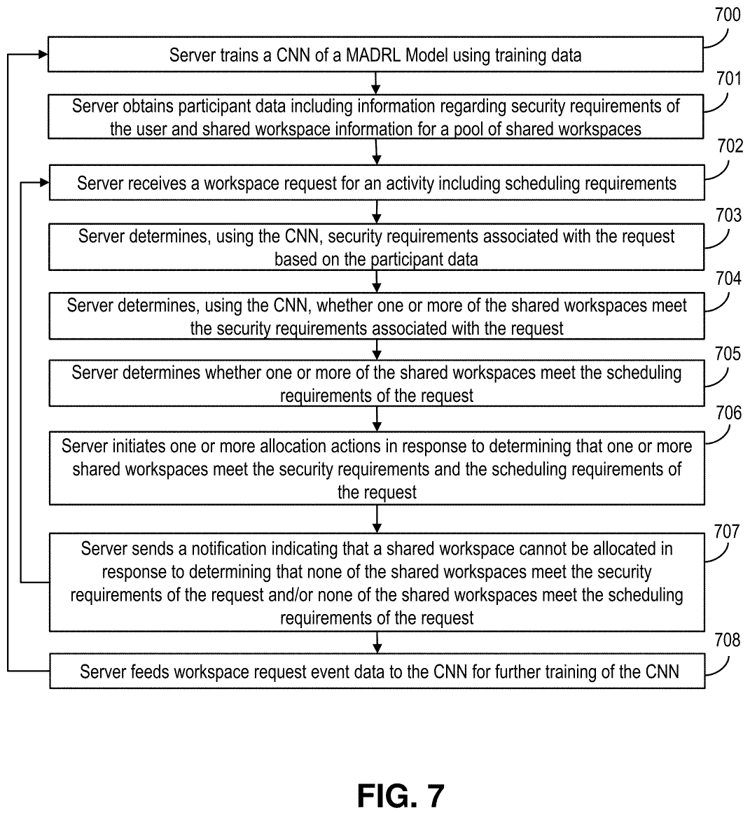

FIG. 7 shows a flowchart of an exemplary method in accordance with aspects of the present invention. Steps of the method may be carried out in the environment of FIG. 4 and are described with reference to elements depicted in FIG. 4.

At step 700, the server 404 trains a CNN (e.g., CNN 508 of FIG. 6) of a Multi-Agent Deep Reinforcement Learning (MADRL) Model using training data. In embodiments, the server 404 provides a virtual environment with simulated profiles of people engaged in different tasks, and the MADRL model is utilized as an artificial intelligence (AI) engine to support the backend and user's virtual profiles stored in a cloud database.

Deep reinforcement learning (deep RL) is a subfield of machine learning that combines reinforcement learning (RL) and deep learning. In general, RL is a process in which an agent learns to make decisions through trial and error. RL considers the problem of a computational or intelligent agent learning which actions to take in an environment in order to maximize a reward. This problem is often modeled mathematically as a Markov decision process (MDP), where an agent at every timestep is in a state s, takes action a, receives a scalar reward and transitions to the next state s′ according to environment dynamics p(s′|s,a). The agent attempts to learn a policy π(a|s), or map from observations to actions, in order to maximize the agent's returns (i.e., expected sum of rewards).

In general, deep RL incorporates deep learning based on artificial neural networks into the solution, allowing agents to make decisions from unstructured input data without manual engineering of the state space. In embodiments, as part of a multi-agent reinforcement mechanism running for sets of different entities in a three-dimensional (3D) environment, the following parameters are taken into account.

Each agent (i.e., software profile of a user) can take an action A being in a particular state. Hence, at each time step, the agent observers a state s, chooses an action a, receives a reward r, and transitions to a new stat s′. Q-learning is used to update the Q-values:

$$Q ( s , a ) = Q ( s , a ) + α ( r + γ {max}_{{a}^{′}} Q ( {s}^{′} , {a}^{′} ) - Q ( s , a ) )$$

In general, for any finite Markov decision process (FMDP), Q-learning finds an optimal policy in the sense of maximizing the expected value of the total reward over any and all successive steps, starting from the current state. The term Q-value refers to the function that the algorithm computes—the expected rewards for an action taken in a given state. In order to compute the optimal satisfaction rating of the agent in said 3d environment, the server 404 makes the following simplifying assumptions: (i) two-dimensional representation of the environment, and (ii) discrete time and space. The above assumptions help in representing the global system state as an image-like tensor, with each channel of the image containing agent and environment specific information, on which the CNN (e.g., CNN 508 of FIG. 6) can be applied.

With continued reference to FIG. 7, at step 701, the server 404 obtains participant data from participants of the environment 400, the participant data including information regarding security requirements of a user (e.g., security policies of an organization) and shared workspace information (e.g., security information, IoT device information, location, availability information) for a pool of shared workspaces (e.g., 412 of FIG. 4). In implementations, the server 404 processes the received participant data to extract parameters (e.g., security parameters) relevant to determining the security needs of a user and the available security at individual shared workspaces in the pool of shared workspaces. User profile data including information for a user (e.g., devices owned by the user, security information for the user, etc.) may be accessed by the server 404 from a remote source, or may be accessed from a local database (e.g., via the data storage module 424). Participant data may include real-time data, such as current occupancy and allocation of shared workspaces in the pool of workspaces 412, and third party data such as public and private events, traffic data, public security data, etc. In embodiments, the data collection module 420 and/or the user profile module 421 of the server 404 implements step 701.

At step 702, the server 404 receives a workspace request including scheduling requirements. In implementations, the scheduling requirements include: an intended activity or activities of a user (e.g., video conference, in-person group meeting, document drafting, teleconference, etc.), a desired date for the intended activity, and a desired time period for the intended activity. For example, a user may access a UI provided by the server 404, via a client device 406, to submit a request for a workspace on Friday from 1:00 pm to 3:00 pm for a confidential teleconference with a client. In embodiments, the workspace module 422 implements step 702.

At step 703, the server 404 determines, using the CNN of the MADRL Model, security requirements associated with the request based on the participant data (e.g., information regarding security requirements of a user and shared workspace information). In embodiments, the machine learning module 423 of the server 404 implements step 703.

At step 704, the server 404 determines, using the CNN of the MADRL Model, whether one or more of the shared workspaces from the pool of shared workspaces meet the security requirements associated with the request. In embodiments, the machine learning module 423 of the server 404 implements step 704.

At step 705, the server 404 determines whether one or more of the shared workspaces from the pool of shared workspaces meets the scheduling requirements of the user. In embodiments, in response to determining that a subset of shared workspaces from the pool of shared workspaces meet the security requirements associated with the request at step 704, the server 404 determines whether one or more of the subset of shared workspaces meets the scheduling requirements of the user. In implementations, the server 404 may rank or prioritize the one or more shared workspaces that meet scheduling requirements of the user based on based on participant data (e.g., security requirements, distance from a user's home, amenities, etc.). Different types participant data may be weighted (e.g., security requirements may have more weight than amenities). In embodiments, the machine learning module 423 of the server 404 implements step 705.

At step 706, in response to determining that one or more shared workspaces from the pool of shared workspaces meets the security requirements of the request and meets the scheduling requirements of the request, the server 404 initiates one or more allocation actions. In embodiments, the server 404 sends one or more recommendations (e.g., in real time) indicating shared workspaces that are available for allocation and meet the security requirements of the request. The allocation action may comprise sending a notification to the user with a list of shared workspaces available to them for allocation (e.g., with options to select a shared workspace); sending a notification to a remote shared workspace manager or owner (e.g., at a shared space server 408) indicating the allocation (e.g., a notification to update a workspace allocation calendar or schedule at a shared space server 408); automatically changing an electronic workspace allocation calendar or schedule at a local or remote site (e.g., at a shared space server 408) and/or automatically update a workspace allocation calendar to schedule the user's use of the shared workspace for the data and time indicated in the workspace request, for example. It can be understood that context may change over time. For example, an event occurring near a shared workspace may be cancelled or scheduled unexpectedly. In implementations, the server 404 provides recommendations to one or more users if a current workspace meets their requirements based on current context, and/or advise one or more users if a better shared workspace (a workspace meeting more of their requirements) becomes available (e.g., due to cancellation). In embodiments, the machine learning module 423 of the server 404 implements step 706.

At step 707, in response to determining that none of the shared workspaces in the pool of shared workspaces meets the security requirements at step 704, and/or in response to determining that none of the shared workspaces in the pool of shared workspaces meets the scheduling requirements of the user, the server 404 sends the user a notification indicating that a workspace cannot be allocated. In implementations, the server 404 provides the user with alternative scheduling options for the user's intended activity (e.g., for alternative dates and times that meet the security requirements of the request). In implementations, the notification includes a request to submit a revised or new workspace request. In embodiments, the user may send the server 404 a revised workspace request in accordance with step 702, and step 702-706 may be repeated until the server 404 determines that one or more of the shared workspaces meet the security requirement and the scheduling requirements of the revised workspace request. In embodiments, the machine learning module 423 of the server 404 implements step 707.

At step 708, the server 404 feeds workspace request event data (e.g., user request data, allocation data, etc.) to the CNN as training data to update the CNN. In embodiments, when a user selects a recommended workspace for allocation based on a list of recommended workspaces sent at step 706, the server 404 feeds workspace request event data as training data to the CNN, including data from the workspace request and the user selected workspace. In embodiments, the machine learning module 423 of the server 404 implements step 708.

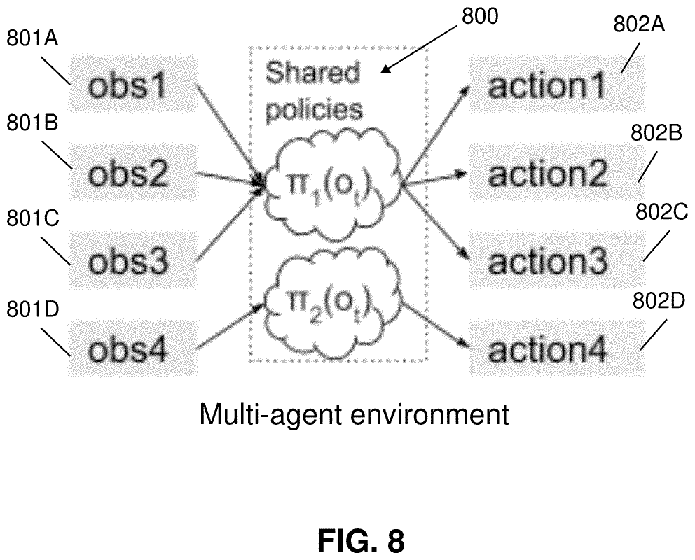

FIG. 8 is a diagram depicting the sharing of learned action selection policies in accordance with aspects of the invention. In implementations, in order to incorporate multi-agent training, the server 404 trains the CNN with one agent at a time and keeps the policies (the agent's action selection modelled as a map using probabilities) of all the other agents fixed during this period. In embodiments, after a set number of training iterations (e.g., observations 801A-801D) of the CNN, the policy 800 learned by the training agent gets distributed by the server 404 to all the other agents of the same type. Accordingly, an agent distributes its policy to all of its allies, but the learning process itself is not distributed. In embodiments, each agent is able to sense the locations of all the other agents, but does not need to explicitly communicate with the other agents about its intent.

In one exemplary scenario, an action (e.g., one of actions 802A-802D of FIG. 8) taken by an agent comprises moving from a first unsecure workspace location to a second secure workspace location based on items owned by the user (e.g., IoT devices) and the profile of the user indicating the user is part of the human resources (HR) group. In this example, the server 404 identifies the optimal environment that would be required in the case of the agent handling confidential information when in a crowded environment.

In another exemplary scenario, an agent comprises an information database handler having a similar user profile (confidential profile) to the HR agent, wherein the agent requires access to secure storage space for securely storing data. In this scenario, the RL agent policy is updated by the server 404 to trigger the generation of secure storage space for the agent based on the similarity of the HR agent profile to the information database handler agent profile. Hence, taking into account policies and agents belonging to different profiles and work items at hand, the server 404 may emulate a surrounding so as to maximize the reward function associated with the agents when certain actions are being taken in the environment. When such emulated simulations overlap over a trained period of time t, with each state transition, it is received by an aggregator of the server 404 to provide the security recommendations of the owner of the simulator in order to design such an environment in real time.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, a workspace request from a user, the workspace request including scheduling requirements for an activity;
determining, by the computing device, security requirements associated with the workspace request utilizing a trained convoluted neural network (CNN) based on participant data including information regarding security requirements of the user and shared workspace information for a pool of shared workspaces;
determining, by the computing device, that one or more of the shared workspaces in the pool of shared workspaces meets the security requirements associated with the workspace request;
determining, by the computing device, that the one or more of the shared workspaces meets the scheduling requirements of the workspace request; and
automatically generating and sending, by the computing device, a notification to the user including the one or more of the shared workspaces.

2. The method of claim 1, further comprising obtaining, by the computing device, the participant data from one or more remote data sources.

3. The method of claim 1, wherein the participant data includes Internet of Things (IoT) device data regarding IoT devices of the shared workspaces in the pool of shared workspaces and security policies of an organization, wherein the IoT device data and the security policies are input into the CNN to determine the security requirements associated with the workspace request.

4. The method of claim 1, further comprising allocating a select one of the one or more of the shared workspaces to the user for a period of time based on the workspace request.

5. The method of claim 4, further comprising sending, by the computing device, workspace request event data to the CNN as training data to further train the CNN, the workspace request event data including the select one of the one or more of the shared workspaces and data from the workspace request.

6. The method of claim 1, wherein the participant data includes real-time security data for one or more locations of the shared workspaces in the pool of shared workspaces, and the participant data is obtained from a third party data device via a network connection.

7. The method of claim 1, wherein the CNN includes hidden layers including at least one layer configured to determine workspace characteristics and availability, and at least one layer configured to determine IoT devices of a workspace, security control availability for a workspace, and available security control functions at a workspace.

8. The method of claim 1, wherein the computing device includes software provided as a service in a cloud environment.

9. A computer program product comprising one or more computer readable storage media having program instructions collectively stored on the one or more computer readable storage media, the program instructions executable to:
obtain participant data including information regarding security requirements of a user and shared workspace information for a pool of shared workspaces;
receive a workspace request from the user, the workspace request including scheduling requirements for an activity;
determine security requirements associated with the workspace request utilizing a trained convoluted neural network (CNN) based on the participant data;
determine whether one or more of the shared workspaces in the pool of shared workspaces meets the security requirements associated with the workspace request;
determine whether the one or more of the shared workspaces meets the scheduling requirements of the workspace request; and
in response to the determining whether the one or more of the shared workspaces meets the security requirements, automatically generate and send a notification to the user including the one or more of the shared workspaces.

10. The computer program product of claim 9, wherein the participant data includes Internet of Things (IoT) device data regarding IoT devices of the shared workspaces in the pool of shared workspaces.

11. The computer program product of claim 9, wherein the participant data includes security policies of an organization, wherein the security policies are input into the CNN to determine the security requirements associated with the workspace request.

12. The computer program product of claim 9, wherein the program instructions are further executable to automatically generate and send a notification to a shared space server allocating a select one of the one or more of the shared workspaces to the user for a period of time based on the workspace request.

13. The computer program product of claim 12, wherein the program instructions are further executable to send workspace request event data to the CNN as training data to further train the CNN, the workspace request event data including the select one of the one or more of the shared workspaces and data from the workspace request.

14. The computer program product of claim 9, wherein the participant data includes real-time security data for one or more locations of the shared workspaces in the pool of shared workspaces, and the participant data is obtained from a third party data device via a network connection.

15. A system comprising:
a processor, a computer readable memory, one or more computer readable storage media, and program instructions collectively stored on the one or more computer readable storage media, the program instructions executable to:
obtain participant data including information regarding security requirements of a user and shared workspace information for a pool of shared workspaces;
receive a workspace request from the user, the workspace request including scheduling requirements for an activity;
determine security requirements associated with the workspace request utilizing a trained convoluted neural network (CNN) based on the participant data;
determine whether one or more of the shared workspaces in the pool of shared workspaces meets the security requirements associated with the workspace request; and
in response to the determining that the one or more of the shared workspaces does not meet the security requirements, automatically generate and send a notification to the user indicating that now secure shared workspaces are available.

16. The system of claim 15, wherein the program instructions are further executable to:
obtain a revised workspace request from the user, the workspace request including scheduling requirements for an activity;
determine security requirements associated with the revised workspace request utilizing the trained convoluted neural network (CNN) based on the participant data;
determine that the one or more of the shared workspaces in the pool of shared workspaces meet the security requirements associated with the revised workspace request;
determine that the one or more of the shared workspaces meets the scheduling requirements of the revised workspace request; and
in response to the determining that the one or more of the shared workspaces meets the security requirements and the scheduling requirements, automatically generate and send a notification to the user indicating the one or more of the shared workspaces are available for allocation.

17. The system of claim 16, wherein the program instructions are further executable to automatically generate and send a notification to a shared space server allocating a select one of the one or more of the shared workspaces to the user for a period of time based on the workspace request.

18. The system of claim 17, wherein the program instructions are further executable to send workspace request event data to the CNN as training data to further train the CNN, the workspace request event data including the select one of the one or more of the shared workspaces and data from the workspace request.

19. The system of claim 15, wherein the participant data includes:
Internet of Things (IoT) device data regarding IoT devices of the shared workspaces in the pool of shared workspaces; and
security policies of an organization, wherein the IOT device data and security policies are input into the CNN.

20. The system of claim 15, wherein the participant data includes real-time security data for one or more locations of the shared workspaces in the pool of shared workspaces, and the participant data is obtained from a third party data device via a network connection.
